(19) United States
(12) Patent Application Publication
(10) Pub. No.: US 2016/0145432 A1
(43) Pub. Date: May 26, 2016

(54) RESIN COMPOSITION AND SEALING MEMBER

(71) Applicant: MITSUBISHI CABLE INDUSTRIES, LTD., Tokyo (JP)

(72) Inventors: Masanori JUJII, Amagasaki-shi, Hyogo (JP); Taishiro SASAKI, Amagasaki-shi, Hyogo (JP); Takeshi IKEDA, Amagasaki-shi, Hyogo (JP)

(73) Assignee: MITSUBISHI CABLE INDUSTRIES, LTD., Tokyo (JP)

(21) Appl. No.: 14/902,157

(22) PCT Filed: Jul. 1, 2014
(86) PCT No.: PCT/JP2014/067491

§ 371 Date: Dec. 30, 2015

(30) Foreign Application Priority Data
Jul. 2, 2013 (JP) 2013-139166

(51) Int. Cl. C08L 81/04

(52) U.S. Cl. CPC C08L 81/04

(57) ABSTRACT

The present invention provides a resin composition containing polyphenylenesulfide (100 parts by weight), carbon fiber (2-15 parts by weight), and a polytetrafluoroethylene powder (5-25 parts by weight), and a sealing member obtained by forming the composition.

### TECHNICAL FIELD

The present invention relates to a resin composition and a sealing member obtained therefrom.

### BACKGROUND ART

As a sealing member obtained from a resin composition, for example, U-seal and seal ring formed by cutting fluororesin such as polytetrafluoroethylene and the like (patent document 1), seal ring formed by injection molding of polyether ether ketone resin and amorphous carbon powder as the main components (patent document 2), chip seal formed from a sliding composition composed of a liquid crystal polymer, fluororesin, and a carbon fiber having an elastic modulus in tension of 10000 kgf/mm² or below (patent document 3) and the like have been proposed. Furthermore, it is known that a chip seal formed from a synthetic resin comprising polyphenylenesulfide, polyimide or liquid crystal polymer as a base material is used for a scroll compressor (patent document 4).

### DOCUMENT LIST

### Patent Documents

patent document 1: JP-A-2010-209925
patent document 2: JP-A-11-343480
patent document 3: JP-A-6-25645
patent document 4: JP-A-2000-213477

### SUMMARY OF THE INVENTION

### Problems to be Solved by the Invention

Abrasion resistance of a sealing member is sometimes improved by increasing the rigidity thereof by adding carbon fiber and the like. However, this causes a problem of an increased amount of leakage in a sealing member having too high a rigidity. This problem is considered to derive from the difficulty in deforming a sealing member having too high a rigidity, in response to the pressure applied during operation of a sealing device, which in turn decreases the adhesiveness to the sealing device. When the rigidity is decreased to deal with the leakage (i.e., flexibility is increased), the abrasion resistance of the sealing member decreases.

The present invention has been made taking note of the above-mentioned situation and aims to provide a sealing member having rigidity which is not too high and superior abrasion resistance.

### Means of Solving the Problems

The present inventors have conducted intensive studies in an attempt to achieve the above-mentioned object and found that a sealing member superior in the balance of flexibility and abrasion resistance can be obtained from a resin composition obtained by adding particular amounts of a carbon fiber and polytetrafluoroethylene (hereinafter sometimes to be abbreviated as “PTFE”) powder to polyphenylenesulfide (hereinafter sometimes to be abbreviated as “PPS”), which resulted in the completion of the present invention. The present invention based on such finding is as described below.

[1] A resin composition comprising 100 parts by weight of polyphenylenesulfide,
2-15 parts by weight of carbon fiber, and
5-25 parts by weight of a polytetrafluoroethylene powder.

[2] The resin composition of the aforementioned [1], wherein the polyphenylenesulfide has a melt flow rate of 15-500 g/10 min.

[3] The resin composition of the aforementioned [1], wherein the polyphenylenesulfide has a melt flow rate of 30-300 g/10 min.

[4] The resin composition of any one of the aforementioned [1]-[3], wherein the carbon fiber is a pitch-based carbon fiber.

[5] The resin composition of any one of the aforementioned [1]-[4], wherein the carbon fiber has an average fiber length of 0.1 - 2.0 mm.

[6] The resin composition of any one of the aforementioned [1]-[5], wherein the carbon fiber has an aspect ratio of 10-200.

[7] The resin composition of any one of the aforementioned [1]-[5], wherein the carbon fiber has an aspect ratio of 25-130.

[8] The resin composition of any one of the aforementioned [1]-[7], wherein the content of the carbon fiber is 3-13 parts by weight per 100 parts by weight of the polyphenylenesulfide.

[9] The resin composition of any one of the aforementioned [1]-[7], wherein the content of the carbon fiber is 5-12 parts by weight per 100 parts by weight of the polyphenylenesulfide.

[10] The resin composition of any one of the aforementioned [1]-[9], wherein the polytetrafluoroethylene powder has an average particle size of 0.01-650 μm.

[11] The resin composition of any one of the aforementioned [1]-[9], wherein the polytetrafluoroethylene powder has an average particle size of 0.05-200 μm.

[12] The resin composition of any one of the aforementioned [1]-[9], wherein the polytetrafluoroethylene powder has an average particle size of 1-100 μm.

[13] The resin composition of any one of the aforementioned [1]-[9], wherein the polytetrafluoroethylene powder has an average particle size of 3-30 μm.

[14] The resin composition of any one of the aforementioned [1]-[13], wherein the content of the polytetrafluoroethylene powder is 8-20 parts by weight per 100 parts by weight of the polyphenylenesulfide.

[15] The resin composition of any one of the aforementioned [1]-[13], wherein the content of the polytetrafluoroethylene powder is 8-18 parts by weight per 100 parts by weight of the polyphenylenesulfide.

[16] The resin composition of any one of the aforementioned [1]-[15], further comprising a graphite powder.

[17] The resin composition of the aforementioned [16], wherein the graphite is synthetic graphite.

[18] The resin composition of the aforementioned [16], wherein the graphite is synthetic scaly graphite or synthetic flake graphite.

[19] The resin composition of the aforementioned [16], wherein the graphite is synthetic flake graphite.

[20] The resin composition of any one of the aforementioned [16]-[19], wherein the graphite powder has an average particle size of 1-250 μm.

[21] The resin composition of any one of the aforementioned [16]-[19], wherein the graphite powder has an average particle size of 3-100 μm.

[22] The resin composition of any one of the aforementioned [16]-[19], wherein the graphite powder has an average particle size of 5-50 μm.

[23] The resin composition of any one of the aforementioned [16]-[22], wherein the content of the graphite powder is 2-10 parts by weight per 100 parts by weight of the polyphenylenesulfide.

[24] The resin composition of any one of the aforementioned [16]-[22], wherein the content of the graphite powder is 2-5 parts by weight per 100 parts by weight of the polyphenylenesulfide.

[25] The resin composition of any one of the aforementioned [1]-[24], further comprising an elastomer.

[26] The resin composition of the aforementioned [25], wherein the elastomer is a thermoplastic elastomer.

[27] The resin composition of the aforementioned [25], wherein the elastomer is a polyolefin-based thermoplastic elastomer.

[28] The resin composition of any one of the aforementioned [25]-[27], wherein the content of the elastomer is 10-40 parts by weight per 100 parts by weight of the polyphenylenesulfide.

[29] The resin composition of any one of the aforementioned [25]-[27], wherein the content of the elastomer is 20-30 parts by weight per 100 parts by weight of the polyphenylenesulfide.

[30] A sealing member obtained by forming the resin composition of any one of the aforementioned [1]-[29].

[31] The sealing member of the aforementioned [30], which has a bending modulus of less than 4,000 MPa.

[32] The sealing member of the aforementioned [30] or [31], which is a seal ring.

[33] The sealing member of the aforementioned [32], wherein the seal ring is a square ring or U-seal.

[34] The sealing member of the aforementioned [32] or [33], wherein the seal ring is used for a scroll compressor for air conditioners.

[35] The sealing member of the aforementioned [30] or [31], which is a dust seal.

### Effect of the Invention

A sealing member having not too high a rigidity and superior in the abrasion resistance can be produced from the resin composition of the present invention. Also, the resin composition of the present invention can be subjected to melt processing such as injection molding and the like, and is superior in the mass productivity and production cost.

### DESCRIPTION OF EMBODIMENTS

The resin composition of the present invention contains polyphenylenesulfide (PPS). Only one kind of PPS may be used, or two or more kinds of PPS may be used in combination.

The melt flow rate (hereinafter sometimes to be abbreviated as “MFR”) of PPS is preferably 15-500 g/10 min, more preferably 30-300 g/10 min. When the MFR is not less than 15 g/10 min, a smooth flow of resin can be secured in a metal mold during injection molding, and when it is not more than 500 g/10 min, production of excess burr in a metal mold can be suppressed. MFR can be measured according to JIS K 7210:1999.

A commercially available product can be used as PPS. Examples of the commercially available product include FZ-2100 of DIC Corporation, TORELINA A-900 of Toray Industries, Inc., 0220A9 of POLYPLASTICS CO., LTD., and the like.

The resin composition of the present invention contains 2-15 parts by weight of carbon fiber per 100 parts by weight of PPS. In the present invention, the value of the parts by weight of each component (carbon fiber etc.) is a value relative to 100 parts by weight of PPS. The content of the carbon fiber is preferably 3-13 parts by weight, more preferably 5-12 parts by weight. Only one kind of carbon fiber may be used, or two or more kinds thereof may be used in combination.

Carbon fiber is used for increasing the rigidity of a sealing member and enhancing the abrasion resistance thereof. In the field of sealing members, a large amount of carbon fiber is used for producing a sealing member requested to show high abrasion resistance. However, the present inventors have conducted intensive studies and found that a sealing member obtained by adding a large amount of carbon fiber to polyphenylenesulfide shows improved rigidity but surprisingly shows inferior abrasion resistance. In the present invention, therefore, the amount of carbon fiber is limited to the aforementioned range, and PTFE powder is used in addition to the carbon fiber, whereby a certain level of flexibility is imparted to a sealing member and abrasion resistance is improved.

As the carbon fiber, for example, conventionally-known various carbon fibers such as pitch-based carbon fiber, PAN (polyacrylonitrile)-based carbon fiber, rayon-based carbon fiber and the like can be used. Of these, pitch-based carbon fiber is preferable, and graphitized pitch-based carbon fiber is more preferable. A pitch-based carbon fiber is graphitized by, for example, a heat treatment at 2,000 - 3,000° C. in an inactive gas.

The average fiber length of carbon fiber is preferably 0.1-2.0 mm. When the average fiber length is not less than 0.1 mm, good abrasion resistance can be imparted to a sealing member, and when it is not more than 2.0 mm, the feed property of a resin composition during kneading becomes fine.

The aspect ratio (=fiber length/fiber diameter) of carbon fiber is preferably 10-200, more preferably 25-130.

The average fiber length and aspect ratio of carbon fiber can be measured by an image analysis method generally performed in the field of carbon fiber.

As the carbon fiber, a commercially available product can be used. Examples of the commercially available product include S-242 and S-247 of Osaka Gas Chemicals Co., Ltd., K223QM and K6371M of Mitsubishi Plastics, Inc., and the like.

The resin composition of the present invention contains 5-25 parts by weight of PTFE powder per 100 parts by weight of PPS. The content of PTFE powder is preferably 8-20 parts by weight, more preferably 8-18 parts by weight. Only one kind of PTFE powder may be used, or two or more kinds thereof may be used in combination.

Using the PTFE powder, the wear coefficient of a sealing member obtained from a resin composition is reduced, and the abrasion resistance thereof can be improved. Since the wear coefficient is reduced, frictional heat during sliding of a sealing member can be suppressed. The suppression of frictional heat is considered to also contribute to the improvement of abrasion resistance.

The average particle size of the PTFE powder is preferably 0.01-650 μm, more preferably 0.05-200 μm, further preferably 1-100 μm, particularly preferably 3-30 μm, from the aspect of dispersibility in a resin composition. The average particle size is measured by a laser diffraction method according to JIS Z 8825-1:2001.

As the PTFE powder, one produced for solid lubricant by a direct polymerization method, a thermal decomposition method, a radiolysis method and the like is preferable for affording good dispersibility. The BET specific surface area of the PTFE powder is preferably 1.3-8.2 m²/g. While the PTFE powder may be any of an unmodified product and a modified product, unmodified PTFE powder is preferable. The surface energy of the unmodified PTFE powder is preferably 170-195 μN/cm. The surface energy is measured by a sessile drop method based on the measurement of a drop contact angle.

As the PTFE powder, a commercially available product can be used. Examples of the commercially available product include Fluon L169E, Fluon L169J and Fluon L173J of ASAHI GLASS CO., LTD., and the like.

The resin composition of the present invention may further contain a graphite powder. Only one kind of graphite powder may be used, or two or more kinds thereof may be used in combination. Using a graphite powder, the frictional coefficient of a sealing member obtained from a resin composition is decreased and the abrasion resistance thereof can be improved.

Graphite is a native element composed of carbon, has a hexagonal system or hexagonal plate-like crystal structure, and shows complete cleavage in one direction. As the graphite powder, natural or synthetic scaly graphite, flake graphite, earthy graphite and the like can be used. Synthetic graphite is preferable from the aspect of quality stability, synthetic scaly or flake graphite is more preferable from the aspect of lubricity of a sealing member, and synthetic flake graphite is further preferable.

The average particle size of a graphite powder is preferably 1-250 μm, more preferably 3-100 μm, further preferably 5-50 μm. The average particle size is measured by a laser diffraction method according to JIS Z 8825-1:2001.

The Mohs hardness of a graphite powder is preferably 1-2. When the Mohs hardness is less than 1, an abrasion resistance-improving effect afforded by the addition of graphite is difficult to obtain, and when it exceeds 2, the member to be sealed (particularly soft material such as aluminum and the like) may be damaged by applying a pressure.

When a graphite powder is used, the content thereof in a resin composition is preferably 2-10 parts by weight, more preferably 2-5 parts by weight, per 100 parts by weight of PPS. When the content is not less than 2 parts by weight, good abrasion resistance can be imparted to a sealing member, and when it is not more than 10 parts by weight, the feed property of a resin composition during kneading becomes fine.

As the graphite powder, a commercially available product can be used Examples of the commercially available product include TOKU CP, CB-150 and UP-35N of Nippon Graphite Industries, Co., Ltd., and the like.

The resin composition of the present invention may further contain an elastomer. Only one kind of elastomer may be used, or two or more kinds thereof may be used in combination. Using an elastomer, the flexibility of a sealing member obtained from a resin composition can be enhanced.

To secure formability of a resin composition, the elastomer is preferably a thermoplastic elastomer (hereinafter sometimes to be abbreviated as “TPE”). Examples of the TPE include polystyrene-based TPE, styrene-butadiene(SB)-based TPE, styrene-ethylene-butylene-styrene(SEBS)-based TPE, polyvinyl chloride-based TPE, polyolefin-based TPE, polyurethane-based TPE, polyester-based TPE, polyamide-based TPE, low crystalline 1,2-polybutadiene-based TPE, chlorinated polymer-based TPE, fluorinated TPE, ion-crosslinked TPE and the like. Of these, particularly preferred is polyolefin-based TPE.

When an elastomer is used, the content thereof in a resin composition is preferably 10-40 parts by weight, more preferably 20-30 parts by weight, per 100 parts by weight of PPS. When the content is not less than 10 parts by weight, flexibility can be imparted to a sealing member obtained from a resin composition. When it is not more than 40 parts by weight, flexibility can be imparted without impairing merits of a sealing member such as heat resistance and mechanical property.

The resin composition of the present invention may contain other additives as long as the effect of the invention is not impaired. Examples of the other additive include fluororesin powder other than PTFE powder, crosslinked rubber powder, glass fiber, ceramic fiber, metal fiber, pigment, filler and the like.

The resin composition of the present invention can be produced by mixing and kneading PPS, carbon fiber and PTFE powder and, where necessary, a graphite powder, an elastomer and other additives. Mixing and kneading is not particularly limited, and a method known in the pertinent field can be used. For mixing and kneading, for example, a roll, a kneader, a Banbury mixer, a tumbling mixer, a twin-screw extruder and the like can be used. The resin composition of the present invention is preferably produced by, as shown in the following Examples, dry blending respective components in a tumbling mixer, and then heating and melt kneading the mixture in a twin-screw extruder and the like. The temperature of heating and melt kneading is generally about 290-340° C., preferably 300-320° C., and the time thereof is generally about 1 min-10 min.

The resin composition of the present invention can be melt-processed, and can be formed by melt processing such as injection molding, casting and the like. From the aspect of mass productivity, injection molding is preferable. In injection molding, a metal mold having a shape corresponding to a sealing member, a resin composition melted by heating is filled in the metal mold and solidified or cured. The temperature of injection molding is generally about 290-340° C., preferably 300-320° C., and the temperature of the metal mold is generally about 100-160° C., preferably 120-150° C., and the time of solidification or curing is generally about 10 sec-1 min. A sealing member having no metal mold corresponding to its shape can be obtained by, for example, forming a rod composed of the resin composition of the present invention, and cutting the rod.

The present invention also provides a sealing member obtained by forming the aforementioned resin composition. The sealing member of the present invention has a certain level of flexibility, and can prevent leakage from a sealing device. The bending modulus in the present invention is preferably less than 4,000 MPa, more preferably less than 3,900 MPa, further preferably less than 3,800 MPa. The bending modulus is measured according to ASTM D790:2002.

Examples of the sealing member of the present invention include dust seal, seal ring and the like. Examples of the dust seal include scraper that protect packing and bearing by preventing invasion of dust from the outside, and the like.

Examples of the seal ring include square ring, U-seal and the like.

The square ring is a cyclic seal having a rectangular cross sectional shape and a cut part generally called abutment.

The U-seal is a cyclic seal having a U-shaped cross sectional shape. When a U-seal is used with a spring housed in a groove, to prevent the spring from being detached, at least one of the two top ends of the U-shaped groove has an overhanging part heading toward the inside of the aforementioned groove and along the circumferential direction of the seal ring. To make the spring more difficult to be detached during use of a U-seal, the aforementioned overhanging part is preferably formed on two top ends over the whole perimeter of the U-seal. To improve seal function, a lip part is preferably formed on two top ends of a U-shaped groove, which extends toward the outside of the aforementioned groove and along the circumferential direction of the U-seal.

The seal ring of the present invention is preferably used for a scroll compressor for air conditioners.

### EXAMPLES

While the present invention is explained in more specifically in the following by referring to Examples, the present invention is not limited by the following Examples. It is of course possible to practice the present invention by modifying as appropriate without departing from the above and below-mentioned gist of the invention, and such modifications are all encompassed in the technical scope of the present invention.

### 1. Starting Materials

The starting materials used in Examples and Comparative Examples are as follows.

### (1) Polyphenylenesulfide (PPS)

“TORELINA A-900” (manufactured by Toray Industries, Inc.), MFR:35 g/10 min

### (2) Carbon Fiber

“S-242” (manufactured by Osaka Gas Chemicals Co., Ltd.), pitch-based carbon fiber, average fiber length: 0.37 mm, aspect ratio: 28

“S-247” (manufactured by Osaka Gas Chemicals Co., Ltd.), pitch-based carbon fiber, average fiber length: 1.7 mm, aspect ratio: 130

### (3) Polytetrafluoroethylene (PTFE) Powder

“Fluon L169E” (manufactured by ASAHI GLASS CO., LTD.), average particle size: 17 μm, BET specific surface area: 2 m²/g

### (4) Graphite Powder

“TOKU CP” (manufactured by Nippon Graphite Industries, Co., Ltd.): synthetic scaly graphite, average particle size: 15 μm

### (5) Elastomer

Glycidyl group-containing olefin-based copolymer composed of glycidyl methacrylic acid 2.5 wt %, methyl acrylate 60 wt %, ethylene 37.5 wt %.

### 2. Preparation of Resin Composition

The compositions of the resin compositions of the Examples and Comparative Examples are shown in the following Table 1 and Table 2. Respective components in the Table were measured, dry blended in a tumbling mixer, and extrusion granulated by a twin-screw extruder at 300-320° C. to prepare each resin composition.

The above-mentioned respective resin compositions (granules) can be cast in a injection machine, melt heated, injected into various given metal molds, and then cooled into a desired shape.

### 3. Evaluation

The obtained resin composition was injection molded under the conditions of cylinder 280-310° C., head 320° C., metal mold temperature 150° C. to prepare test pieces to be used for the following tests (ASTM D638:1995, ASTM D790:2002, pin-on-disk abrasion test). The tensile property, bending property and abrasion resistance of the test pieces were evaluated by the methods described below. The results are shown in the following Tables 1 and 2.

### (1) Tensile Property

A tensile test was performed according to ASTM D638:1995, and tensile properties (tensile strength and tensile strain at break) were measured. A tensile strain at break of not less than 5% was judged to be superior in tensile property.

### (2) Bending Property

A bending test was performed according to ASTM D790:2002, and bending properties (bending modulus and bending strength) were measured as an index of flexibility. A bending modulus of less than 4,000 MPa was judged to be superior in flexibility.

### (3) Abrasion Resistance

Using a disc (S45C steel plate, surface roughness measured by JIS B 0601: Ra=0.8), a pin-on-disk abrasion test 35 including abrading a test piece (cylinder of diameter 5 mm×length 12 mm) under the conditions of air atmosphere, atmospheric temperature: 120° C., disc rotating speed: 3 m/sec was performed, and endurance time was measured as an index of abrasion resistance.

To be specific, the circular surface of the test piece (cylinder) was abraded by the disc first under the abrasion pressure of 2 MPa for 3 hr, then 3 MPa for 3 hr, and finally 4 MPa for 3 hr. When the abrasion loss of the test piece reached 0.7 mm, the test was completed, and the time thereof was measured as an endurance time. When the abrasion loss of the test piece did not reach 0.7 mm even after the completion of the disk abrasion test for 9 hr (i.e., endurance time of 9 hr), the test piece was judged to be superior in the abrasion resistance.

The test piece was prepared by cutting a test piece injection molded into a rather large size.

TABLE 1

| | | | Example | | | | | | | |
|---|---|---|---|---|---|---|---|---|---|---|
| | | | 1 | 2 | 3 | 4 | 5 | 6 | 7 | 8 |
| starting | PPS | parts by weight | 100 | 100 | 100 | 100 | 100 | 100 | 100 | 100 |
| material | elastomer | parts by weight | | | | | | 25 | | 20 |
| | PTFE powder | parts by weight | 20 | 20 | 8 | 20 | 20 | 8 | 20 | 20 |
| | carbon fiber (S-242) | parts by weight | 12 | 6 | 3 | 3 | | 3 | 3 | 3 |
| | carbon fiber (S-247) | parts by weight | | | | | 3 | | | |
| | graphite | parts by weight | | | | | | | 3 | 3 |
| tensile | tensile strength | MPa | 82.5 | 76.0 | 59.4 | 56.5 | 59.0 | 39.0 | 64.6 | 44.3 |
| property | tensile strain at break | % | 6.3 | 7.5 | 7.6 | 11.2 | 8.8 | 17.0 | 10.0 | 15.5 |
| bending | bending strength | MPa | 116 | 111 | 108 | 106 | 105 | 87 | 107 | 88 |
| property | bending modulus | MPa | 3880 | 3500 | 3400 | 3200 | 3250 | 2000 | 3820 | 2350 |
| abrasion | endurance time | hr | 9.0 | 9.0 | 9.0 | 9.0 | 9.0 | 9.0 | 9.0 | 9.0 |
| resistance | | | | | | | | | | |

TABLE 2

| | | | Comparative Example | | | | | |
|---|---|---|---|---|---|---|---|---|
| | | | 1 | 2 | 3 | 4 | 5 | 6 |
| starting | PPS | parts by weight | 100 | 100 | 100 | 100 | 100 | 100 |
| material | elastomer | parts by weight | | | | | 25 | |
| | PTFE powder | parts by weight | | | 20 | 20 | | 10 |
| | carbon fiber | parts by weight | | 40 | | 40 | | |
| | (S-242) | | | | | | | |
| | carbon fiber | parts by weight | | | | | | |
| | (S-247) | | | | | | | |
| | graphite | parts by weight | | | | | | 25 |
| tensile | tensile strength | MPa | 82.0 | 115.0 | 78.0 | 105.0 | 30.6 | 88.5 |
| property | tensile strain at break | % | 15.0 | 0.8 | 10.5 | 1.2 | 28.8 | 2.6 |
| bending | bending strength | MPa | 130 | 170 | 98 | 125 | 85 | 104 |
| property | bending modulus | MPa | 3800 | 12000 | 3200 | 10000 | 1600 | 7800 |
| abrasion | endurance time | hr | 0.5 | 1.6 | 0.9 | 4.2 | <0.1 | 4.7 |
| resistance | | | | | | | | |

In Examples 1-8 using compositions satisfying the requirements of the present invention, test pieces (molded articles) superior in the balance of flexibility and abrasion resistance and having a bending modulus of less than 4,000 MPa, and an endurance time of 9 hr were obtained.

On the other hand, in Comparative Example 1 without using carbon fiber and PTFE powder, and Comparative Examples 3 and 5 without using carbon fiber, test pieces ensuring a certain level of flexibility and having a bending modulus of less than 4,000 MPa were obtained. However, they were inferior in abrasion resistance.

In Comparative Examples 2 and 4 using carbon fiber in excess, and Comparative Example 6 without using carbon fiber but using graphite, test pieces having high rigidity (bending modulus) were obtained. These test pieces had high rigidity, but were inferior in abrasion resistance.

### INDUSTRIAL APPLICABILITY

A sealing member having not too high a rigidity and superior in abrasion resistance can be produced from the resin composition of the present invention. The sealing member of the present invention is useful as a seal ring (particularly, seal ring used for a scroll compressor for air conditioners), a dust seal and the like.

This application is based on a patent application No. 2013-139166 filed in Japan, the contents of which are incorporated in full herein.

1-3. (canceled)

4. A sealing member obtained by forming a resin composition, wherein the resin composition comprises 100 parts by weight of polyphenylenesulfide, 2-15 parts by weight of carbon fiber, and 5-25 parts by weight of a polytetrafluoroethylene powder.

5. The sealing member according to claim 4, which has a bending modulus of less than 4,000 MPa.

6. The sealing member according to claim 4, which is a seal ring.

7. The sealing member according to claim 6, wherein the seal ring is a square ring or U-seal.

8. The sealing member according to claim 6, wherein the seal ring is used for a scroll compressor for air conditioners.

9. The sealing member according to claim 4, which is a dust seal.

10. The sealing member according to claim 4, wherein the resin composition further comprises a graphite powder.

11. The sealing member according to claim 4, wherein the resin composition further comprises an elastomer.

12. The sealing member according to claim 6, wherein the resin composition further comprises a graphite powder.

13. The sealing member according to claim 6, wherein the resin composition further comprises an elastomer.

14. The sealing member according to claim 5, which is a seal ring.

15. The sealing member according to claim 7, wherein the seal ring is used for a scroll compressor for air conditioners.

16. The sealing member according to claim 5, which is a dust seal.
